(19) United States
(12) Patent Application Publication
(10) Pub. No.: US 2025/0132511 A1
(43) Pub. Date: Apr. 24, 2025

(54) SUBSTRATE CONNECTOR, METHOD OF MANUFACTURING SUBSTRATE CONNECTOR, AND TERMINAL

(71) Applicant: J.S.T. MFG. CO., LTD., Tokyo (JP)

(72) Inventors: Koji WADA, Miyoshi-shi (JP); Kazumasa OI, Miyoshi-shi (JP)

(73) Assignee: J.S.T. MFG. CO., LTD., Tokyo (JP)

(21) Appl. No.: 18/901,657

(22) Filed: Sep. 30, 2024

(30) Foreign Application Priority Data
Oct. 23, 2023 (JP) 2023-182061

(51) Int. Cl. H01R 12/58; H01R 12/72; H01R 12/75; H01R 43/20

(52) U.S. Cl. CPC H01R 12/585; H01R 12/722; H01R 43/205; H01R 12/75

(57) ABSTRACT

A substrate connector includes a terminal and an inner housing. The terminal includes a first connecting portion extending in a first direction, a second connecting portion extending in a second direction, and a bridge portion. The bridge portion includes a first extending portion extending in the first direction from the first connecting portion, a second extending portion extending in the second direction from the second connecting portion, and a curved portion connecting the first extending portion and the second extending portion. The second extending portion includes a pair of press-fit protrusions protruding in directions opposite to each other in the third direction. The second extending portion and the curved portion are accommodated in an accommodation groove provided in an end surface of the inner housing in the first direction. A pair of press-fit protrusions are press-fitted and fixed in a pair of inner side surfaces of the accommodation groove. The first extending portion is loosely fitted to the inner peripheral surface of the insertion hole that opens in the groove bottom surface of the accommodation groove.

### CROSS REFERENCE TO RELATED APPLICATION

The present application corresponds to Japanese Patent Application No. 2023-182061 filed on Oct. 23, 2023 in the Japan Patent Office, and the entire disclosure of this application is incorporated herein by reference.

### BACKGROUND OF THE INVENTION

### Field of the Invention

The present invention relates to a substrate connector, a method of manufacturing a substrate connector, and a terminal.

### Description of Related Arts

The substrate connector disclosed in Japanese Patent No. 7043362 includes a terminal having an intermediate portion between a first connecting portion connected to an electric wire inside the housing and a second connecting portion connected to the substrate outside the housing. The intermediate portion includes an R-shaped portion, and orthogonally connects the first connecting portion and the second connecting portion.

The intermediate portion includes a portion extending in the extending direction of the first connecting portion between the R-shaped portion and the first connecting portion. This portion includes a press-fit projection portion press-fitted and fixed to the housing and also includes a wide portion wider than the adjacent portion on the R-shaped portion side than the press-fit projection portion.

The wide portion includes a pair of projection portions protruding from the main body of the intermediate portion to both sides, and the pair of projection portions include a pair of seat portions having a wide area that can be pressed by a pressing jig at the time of press fitting. Therefore, the wide portion has a considerably wider width than the adjacent portion, and the impedance decreases. Therefore, in a case where high frequency transmission is performed, impedance matching is difficult to achieve.

### SUMMARY OF THE INVENTION

A preferred embodiment of the present invention provides a substrate connector that facilitates impedance matching.

A preferred embodiment t of the present invention provides a substrate connector including a terminal and an insulating housing. The terminal includes, with a first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion. The bridge portion includes a first extending portion extending in the first direction from the first connecting portion, a second extending portion extending in the second direction from the second connecting portion, and a curved portion connecting between the first extending portion and the second extending portion. The housing includes an end surface in the first direction, an accommodation groove provided in the end surface and accommodating the second extending portion and curved the portion, the accommodation groove including a pair of inner side surfaces opposing to each other in the third direction and a groove bottom surface, and an insertion hole that opens in the groove bottom surface of the accommodation groove and extends in the first direction. The second extending portion includes a pair of press-fit protrusions protruding in directions opposite to each other in the third direction and are press-fitted and fixed in the pair of inner side surfaces of the accommodation groove. The first extending portion is loosely fitted to an inner peripheral surface of the insertion hole.

According to this configuration, the press-fit protrusions for fixing the terminal to the housing is provided on the second extending portion of the terminal. It is not necessary to provide a press-fit protrusion as described in Japanese Patent No. 7043362 in the first extending portion loosely fitted (that is, not press-fitted) in the insertion hole of the housing. Therefore, the first extending portion need not be provided with a wide portion having a large width and having a pair of projection portions having a large area for receiving a press-fitting jig at the time of press-fitting. Therefore, it is possible to suppress a decrease (or fluctuation) in the impedance of the first extending portion, and it is easy to match the impedance with respect to high frequency transmission.

In one preferred embodiment, the first extending portion includes a pair of projection portions protruding in directions opposite to each other in the third direction and including a carrier cut mark on an end surface. According to this configuration, the pair of projection portions including the carrier cut mark that need not receive the press-fitting jig can minimize the protruding amount in the third direction. Therefore, the protruding amount of the pair of projection portions including the carrier cut mark in the third direction can be adjusted from the minimum to an appropriate protruding amount, and the adjustment range of the impedance expands. As a result, the impedance can be more easily matched with high frequency transmission.

In one preferred embodiment, the terminal includes a plurality of terminals arranged at predetermined intervals in the third direction. According to this configuration, the distance between the adjacent terminals can be reduced.

In one preferred embodiment, the pair of press-fit protrusions are disposed at an end portion of the second extending portion adjacent to the curved portion. The second extending portion includes a pressed portion that can be pressed in the first direction in a region including at least the end portion. The pressed portion includes a pressed surface extending in the second direction and the third direction. According to this configuration, the distance between the pressed surface of the terminal and the first extending portion is short in the second direction. Therefore, when the pressed surface is pressed to press-fit the pair of press-fit protrusions, even if the first extending portion receives frictional force from the insertion hole, it is possible to suppress the occurrence of unintended deformation of the curved portion and the like.

A preferred embodiment of the present invention provides a method of manufacturing a substrate connector, which includes at least steps (S1) and (S2) described below.

(S1) A step of loosely inserting and fitting a part of a first extending portion of a terminal into an insertion hole that opens in a groove bottom surface of an accommodation groove provided in an end surface in a first direction of an insulating housing and extends in the first direction so as to temporarily hold, in the housing, a terminal including, with the first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion, the bridge portion including a first extending portion extending in the first direction from the first connecting portion, a second extending portion extending in the second direction from the second connecting portion, and a curved portion connecting between the first extending portion and the second extending portion.

(S2) A step of pressing the second extending portion of the temporarily held terminal in the first direction to press-fit and fix a pair of press-fit protrusions provided on the second extending portion and protruding in directions opposite to each other in the third direction in a pair of inner side surfaces of the accommodation groove which oppose to each other in the third direction.

According to this configuration, when the second extending portion of the terminal temporarily held in the housing is press-fitted and fixed in the accommodation groove of the inner housing, the frictional force received by the first extending portion from the insertion hole into which the first extending portion is loosely fitted is small. Therefore, the occurrence of unintended deformation of the curved portion and the like can be suppressed.

According to one preferred embodiment, in the step (S2), the pair of press-fit protrusions are disposed at an end portion of the second extending portion adjacent to the curved portion. The second extending portion includes a pressed portion that can be pressed in the first direction in a region including at least the end portion. The pressed portion includes a pressed surface extending in the second direction and the third direction. According to this configuration, the distance between the pressed surface of the terminal and the first extending portion is short in the second direction. Therefore, when the pressed surface is pressed to press-fit the pair of press-fit protrusions, even if the first extending portion receives frictional force from the insertion hole, it is possible to suppress the occurrence of unintended deformation of the curved portion and the like.

One preferred embodiment of the present invention provides a terminal including, with a first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion. The bridge portion includes a first extending portion extending in the first direction from the first connecting portion, a second extending portion extending in the second direction from the second connecting portion, and a curved portion connecting the first extending portion and the second extending portion. The second extending portion includes a pair of press-fit protrusions protruding in directions opposite to each other in the third direction. According to this configuration, it is possible to realize the terminal that easily matches impedance with high frequency transmission when used for the substrate connector.

In one preferred embodiment, the first extending portion includes a pair of projection portions protruding in directions opposite to each other in the third direction and including a carrier cut mark on an end surface. According to this configuration, the pair of projection portions including the carrier cut mark that need not receive the press-fitting jig can minimize the protruding amount in the third direction. Therefore, the protruding amount of the pair of projection portions including the carrier cut mark in the third direction can be adjusted from the minimum to an appropriate protruding amount, and the adjustment range of the impedance expands. As a result, in a case where the terminal is used for the substrate connector, the impedance can be more easily matched with high frequency transmission.

According to one preferred embodiment, the pair of press-fit protrusions are disposed at an end portion of the second extending portion adjacent to the curved portion, the second extending portion includes a pressed portion that is configured to be pressed in the first direction in a region including at least the end portion, and the pressed portion includes a pressed surface extending in the second direction and the third direction. According to this configuration, the distance between the pressed surface of the terminal and the first extending portion is short in the second direction. Therefore, in a case where the terminal is used for the substrate connector, when the pressed surface is pressed to press-fit the pair of press-fit protrusions into the insertion hole of the housing, even if the first extending portion receives frictional force from the insertion hole, it is possible to suppress the occurrence of unintended deformation of the curved portion and the like.

### BRIEF DESCRIPTION OF THE DRAWINGS

FIGS. 1A and 1B are perspective views of a substrate connector and a mating connector before and after being fitted to each other according to a preferred embodiment of the present invention.

FIGS. 2A and 2B are perspective views of the substrate connector from different angles.

FIG. 3 is an exploded perspective view of the substrate connector.

FIG. 4 is a front view of a substrate connector mounted on a circuit board.

FIG. 5 is an enlarged perspective view of terminals.

FIG. 6 is a front view of an inner housing.

FIG. 7 is a perspective view of a subassembly including the terminals and the inner housing.

FIGS. 8A and 8B are assembly process diagrams of the subassembly of the substrate connector.

FIG. 9 is a longitudinal sectional view of the substrate connector.

FIG. 10 is a transverse sectional view of the substrate connector fitted to the mating connector.

FIG. 11 is a process diagram illustrating a modification of the assembly process of the subassembly of the substrate connector.

### DETAILED DESCRIPTION OF THE PREFERRED EMBODIMENT

Hereinafter, preferred embodiments embodying the present invention will be described with reference to the accompanying drawings.

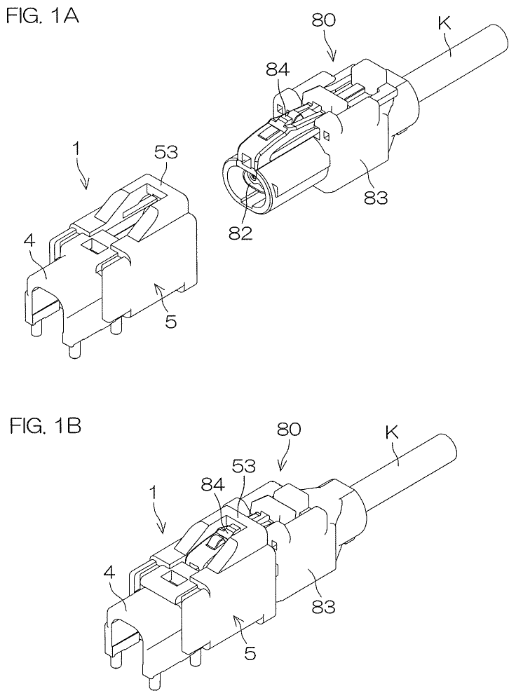

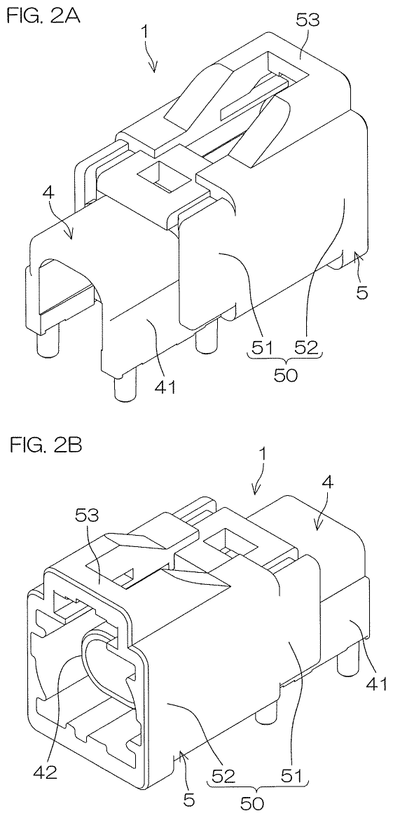

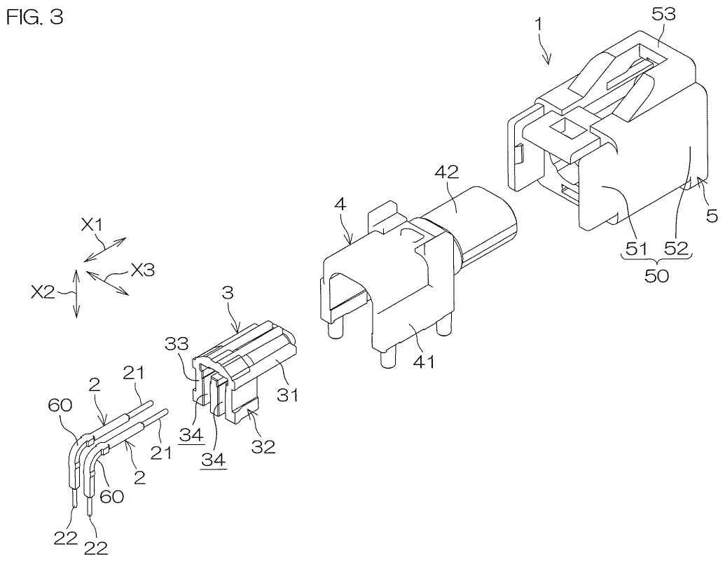

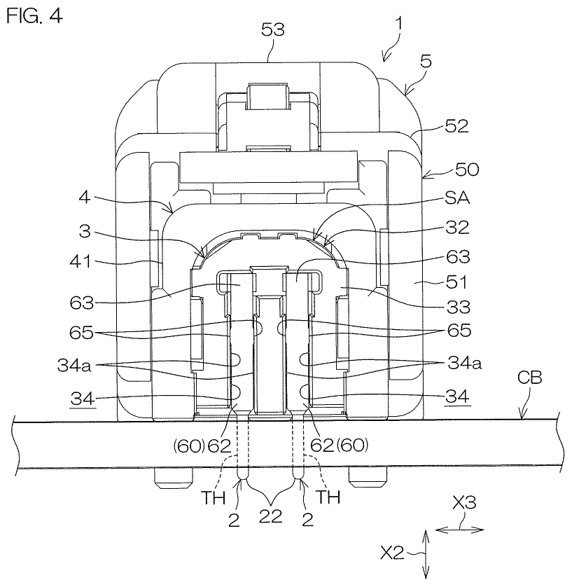

FIGS. 1A and 1B are perspective views of a substrate connector 1 and a mating connector 80 before and after being fitted to each other according to a preferred embodiment of the present invention. FIGS. 2A and 2B are perspective views of the substrate connector 1 from different angles, and FIG. 3 is an exploded perspective view of the substrate connector 1. FIG. 4 is a front view of the substrate connector 1 mounted on a circuit board CB.

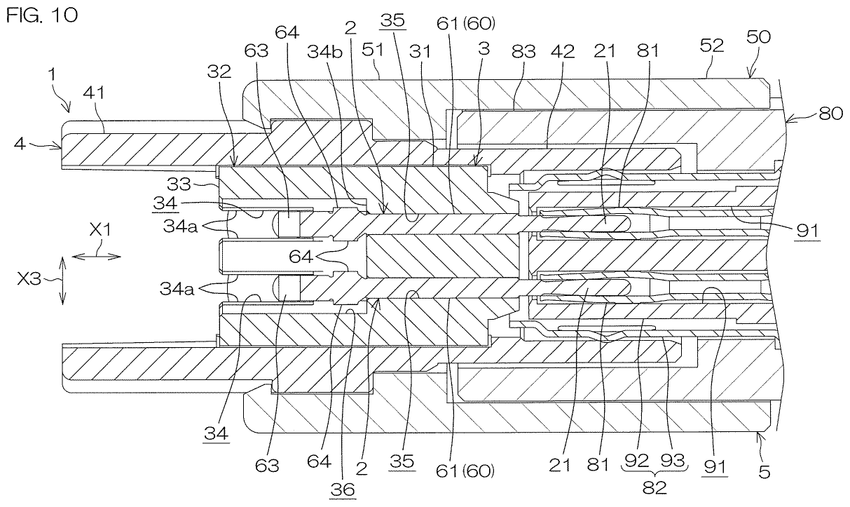

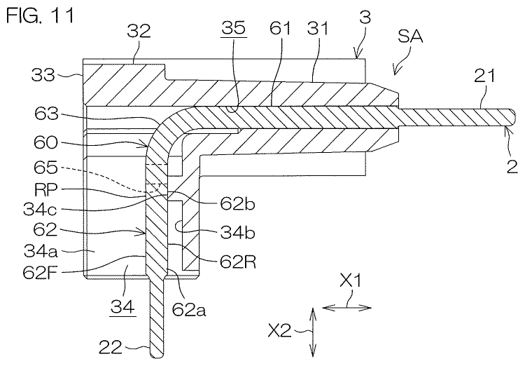

As illustrated in FIGS. 1A and 1B, the mating connector 80 is a cable connector connected to an end portion of a communication cable K. The mating connector 80 is connected to the substrate connector 1 from the rear. As illustrated in FIG. 1A, the mating connector 80 includes a plurality of mating terminals 81 (see FIG. 10) that are female terminals, an insertion projection portion 82 that holds the mating terminals 81, an insulating mating outer housing 83 that accommodates the insertion projection portion 82, and an elastically deformable lock arm 84 supported on an outer surface of the mating outer housing 83.

Each of the mating terminals 81 is connected to a corresponding electric wire (not illustrated) of the communication cable K. As illustrated in FIG. 10 which is a transverse sectional view of the substrate connector 1 fitted to the mating connector 80, the insertion projection portion 82 includes an insulating mating inner housing 92 including a mating terminal holding hole 91 in which the mating terminal 81 is accommodated and held, and a mating metal shell 93 surrounding the periphery of the mating inner housing 92. The mating metal shell 93 is connected to a shield line (not illustrated) of the communication cable K.

As illustrated in FIG. 3, the substrate connector 1 includes a plurality of conductive terminals 2, an insulating inner housing 3, a conductive metal shell 4, and an insulating outer housing 5. As illustrated in FIG. 4, the substrate connector 1 is mounted on the circuit board CB.

As shown in FIGS. 2A and 2B, the rear portion of the metal shell 4 is fitted and held in the outer housing 5. As illustrated in FIG. 3, the terminal 2 is a male terminal, and a plurality of the terminals 2 are provided. An intermediate portion of the terminal 2 is accommodated and held in the inner housing 3, and the pair of end portions of the terminal 2 protrude from the inner housing The inner housing 3 is accommodated and 3 (see FIG. 7). held in the metal shell 4.

First, the terminal 2 of the substrate connector 1 will be described.

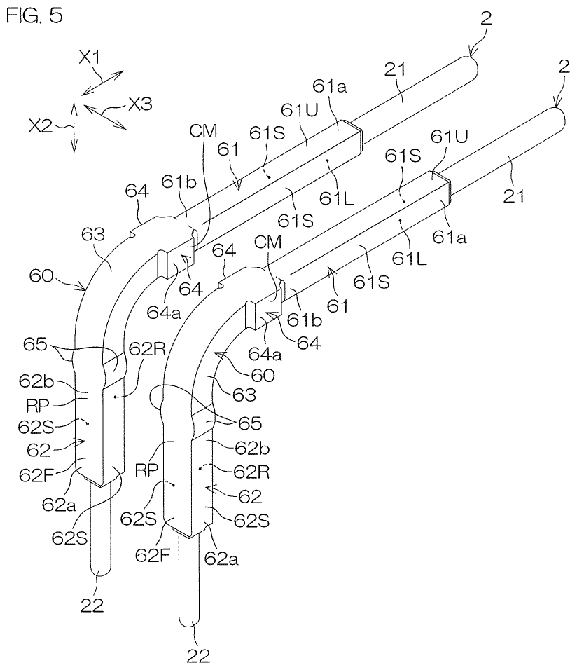

FIG. 5 is an enlarged perspective view of the terminals 2. As illustrated in FIG. 5, a first direction X1, a second direction X2, and a third direction X3 are three orthogonal directions orthogonal to each other. Each terminal 2 includes a first connecting portion 21 extending in the first direction X1 and connectable to the corresponding mating terminal 81 (see FIG. 10) of the mating connector 80, a second connecting portion 22 extending in the second direction X2 and connectable to the circuit board CB (see FIG. 4), and a bridge portion 60 connecting the first connecting portion 21 and the second connecting portion 22. As illustrated in FIG. 4, the second connecting portion 22 is inserted through a through hole TH of the circuit board CB to form a dip terminal to be soldered to the conductor portion on the rear surface of the circuit board CB.

As shown in FIG. 5, the bridge portion 60 includes a first extending portion 61, a second extending portion 62, and an R-shaped curved portion 63 connecting the first extending portion 61 and the second extending portion 62. The first extending portion 61 extends in the first direction X1 from the first connecting portion 21 to the curved portion 63. The first extending portion 61 includes a first end portion 61a adjacent to the first connecting portion 21 and a second end portion 61b adjacent to the curved portion 63. The first extending portion 61 includes a pair of projection portions 64 disposed on the second end portion 61b and protruding in directions opposite to each other in the third direction X3. Each of the pair of projection portions 64 includes a carrier cut mark CM on an end surface 64a. The carrier cut mark CM is a mark cut from a carrier (not illustrated) connecting a plurality of terminals in a band shape in a chain terminal which is a manufacturing intermediate.

The first extending portion 61 is formed in a rectangular parallelepiped shape including a pair of surfaces (an upper surface 61U and a lower surface 61L in FIG. 5) extending in the first direction X1 and the third direction X3 and a pair of surfaces (a pair of side surfaces 61S in FIG. 5) extending in the first direction X1 and the second direction X2. The pair of projection portions 64 including the pair of carrier cut marks CM protrude from the pair of side surfaces 61S.

The second extending portion 62 extends in the second direction X2 from the second connecting portion 22 to the curved portion 63. The second extending portion 62 includes a first end portion 62a adjacent to the second connecting portion 22 and a second end portion 62b adjacent to the curved portion 63. The second extending portion 62 includes a pair of press-fit protrusions 65 disposed at the second end portion 62b and protruding in directions opposite to each other in the third direction X3. The second extending portion 62 includes a pressed surface RP that extends in the second direction X2 and the third direction X3 and can be pressed in the first direction X1 at a position close to the pair of press-fit protrusions 65.

The second extending portion 62 is formed in a rectangular parallelepiped shape including a pair of surfaces (a front surface 62F and a rear surface 62R in FIG. 5) extending in the second direction X2 and the third direction X3 and a pair of surfaces (a pair of side surfaces 62S in FIG. 5) extending in the first direction X1 and the second direction X2. The pair of press-fit protrusions 65 protrude from the pair of side surfaces 62S of the second extending portion 62 respectively. The pressed surface RP is provided on the front surface 62F of the second extending portion 62.

Next, the inner housing 3 will be described.

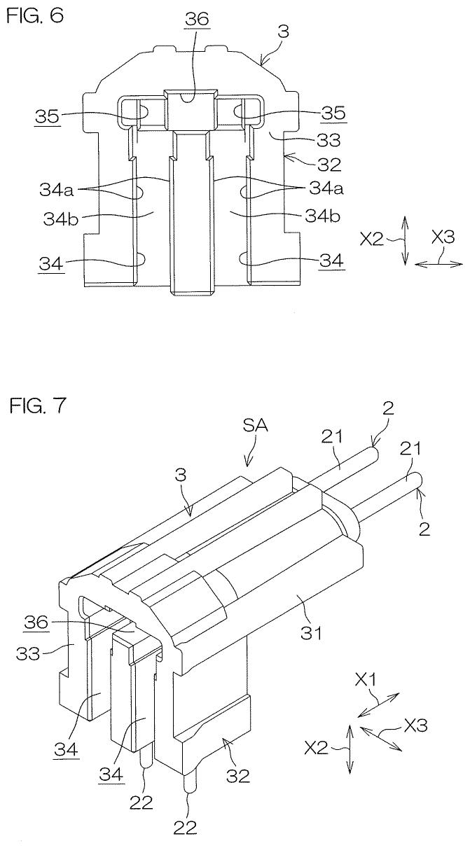

FIG. 6 is a front view of the inner housing 3. FIG. 7 is a perspective view of a subassembly SA including the terminals 2 and the inner housing 3. As illustrated in FIG. 7, the inner housing 3 includes a first portion 31 extending in the first direction X1 and a second portion 32 extending in the second direction X2.

The inner housing 3 includes an end surface 33 in the first direction X1 provided on the second portion 32, a plurality of accommodation grooves 34 provided in the end surface 33 and extending in the second direction X2, a plurality of insertion holes 35 (see FIG. 6) extending in the first direction X1, and a communication groove 36. The first portion 31 extends in the first direction X1 from the upper portion of the second portion 32. The communication groove 36 is provided in the end surface 33, extends in the third direction X3 and causes the end portions (upper end portions) of the plurality of accommodation grooves 34 to communicate with each other. The communication groove 36 accommodates the projection portions 64 of the first extending portions 61 of the plurality of terminals 2 with a gap (see FIG. 10).

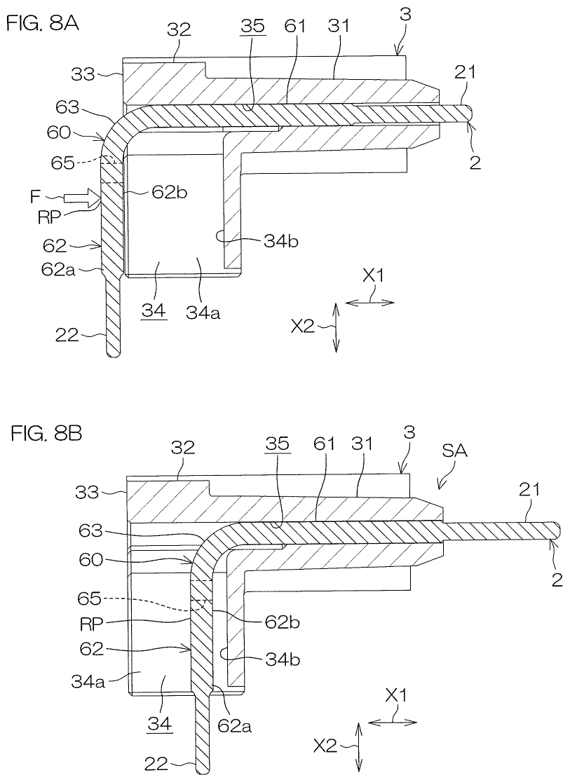

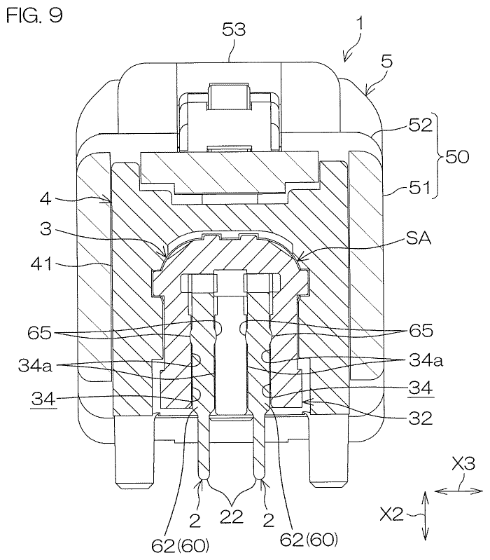

The accommodation groove 34 accommodates the second extending portion 62 and the curved portion 63 of the terminal 2 (see FIG. 8B). The accommodation groove 34 includes a pair of inner side surfaces 34a (see FIG. 9 which is a longitudinal sectional view of the substrate connector 1) facing each other in the third direction X3 and in which the pair of press-fit protrusions 65 are press-fitted and fixed and a groove bottom surface 34b (see FIGS. 6 and 8B). The pair of inner side surfaces 34a are surfaces extending in the first direction X1 and the second direction X2. The groove bottom surface 34b is a surface extending in the second direction X2 and the third direction X3.

As illustrated in FIG. 6, the insertion hole 35 opens in the groove bottom surface 34b of the accommodation groove 34. The insertion hole 35 has a rectangular cross section allowing the loose-fitting of the first extending portion 61 having a rectangular cross section. As illustrated in FIG. 10, the first extending portion 61 is inserted into the insertion hole 35 in a loose-fit state.

When the substrate connector 1 is manufactured, the manufactured terminal 2 is press-fitted and fixed in the inner housing 3, whereby the subassembly SA (see FIG. 7) including the terminal 2 and the inner housing 3 is assembled. The method of manufacturing the substrate connector 1 includes at least the following steps (S1) and (S2). FIGS. 8A and 8B are assembly process diagrams of the subassembly SA of the substrate connector 1.

As illustrated in FIG. 8A, step (S1) is a step of loosely inserting and fitting a part of the first extending portion 61 of the terminal 2 into the insertion hole 35 of the inner housing 3 so as to temporarily hold the manufactured terminal 2 in the inner housing 3.

As illustrated in FIG. 8B, step (S2) is a step of press-fitting the pair of press-fit protrusions 65 of the second extending portion 62 of the temporarily held terminal 2 into the pair of inner side surfaces 34a of the accommodation groove 34 of the inner housing 3. The pressed surface RP close to the pair of press-fit protrusions 65 in the second extending portion 62 of the terminal 2 temporarily held in step (S1) is pressed in the first direction X1 by a pressing force F by a press-fit jig (not illustrated). As a result, the pair of press-fit protrusions 65 are press-fitted into the pair of inner side surfaces 34a of the accommodation groove 34, and the subassembly SA is assembled as illustrated in FIG. 8B. A press-fitting completion position of the terminal 2 is positioned by a pressing position of a press-fitting jig (not illustrated).

Next, the metal shell 4 will be described.

The metal shell 4 is integrally formed by, for example, zinc die casting. As illustrated in FIGS. 3 and 10, the metal shell 4 includes a first portion 41 that accommodates and holds the inner housing 3 and a second portion 42 that protrudes from the first portion 41 to the rear in the first direction X1 (on the mating connector 80 side). The first portion 41 surrounds the inner housing 3. The second portion 42 accommodates the first connecting portion 21 of the terminal 2 protruding from the inner housing 3.

As illustrated in FIG. 10, in the fitted state of the substrate connector 1 and the mating connector 80, the insertion projection portion 82 of the mating connector 80 is inserted and fitted in the second portion 32 of the inner housing 3. The first connecting portion 21 of the terminal 2 of the substrate connector 1 is inserted and fitted in the mating terminal 81 in the mating terminal holding hole 91 of the mating inner housing 92. In addition, the mating metal shell 93 is inserted and fitted in the second portion 42 of the metal shell 4 of the substrate connector 1, and the metal shell 4 and the mating metal shell 93 are electrically connected.

Next, the outer housing 5 will be described.

As illustrated in FIGS. 2A and 2B, the outer housing 5 includes an outer housing main body 50 including a first portion 51 and a second portion 52 and a lock latching portion 53. The first portion 51 of the outer housing main body 50 holds the rear portion of the first portion 41 of the metal shell 4.

As illustrated in FIG. 10, the second portion 52 of the outer housing main body 50 accommodates the second portion 42 of the metal shell 4. The mating outer housing 83 of the mating connector 80 is inserted and fitted into a gap space between the second portion 52 of the outer housing main body 50 and the second portion 42 of the metal shell 4. The insertion projection portion 82 of the mating connector 80 is inserted and fitted into the second portion 42 of the metal shell 4.

As illustrated in FIG. 2A, the lock latching portion 53 is a groove-shaped frame formed to protrude on the outer surface of the second portion 52 of the outer housing main body 50. As illustrated in FIG. 1B, when the substrate connector 1 and the mating connector 80 are fitted to each other, the hook portion of the lock arm 84 of the mating connector 80 elastically climbs over and is latched on the lock latching portion 53, whereby the fitted state between the substrate connector 1 and the mating connector 80 is locked.

According to the substrate connector 1 of one preferred embodiment, as shown in FIG. 5, the press-fit protrusion 65 for fixing the terminal 2 to the inner housing 3 is provided in the second extending portion 62 extending in the second direction X2. In the first extending portion 61 (see FIG. 10) loosely fitted (that is, not press-fitted) in the insertion hole 35 of the inner housing 3, it is not necessary to provide a press-fit protrusion as described in Japanese Patent No. 7043362, and thus, it is not necessary to provide a wide portion having a large width and having a pair of projection portions having a large area for receiving the press-fit jig at the time of press-fitting in the first extending portion 61. Therefore, it is possible to suppress a decrease (or fluctuation) in the impedance of the first extending portion 61, and it is easy to match the impedance with respect to high frequency transmission. In addition, in a case where the plurality of terminals 2 arranged at predetermined intervals in the third direction X3 are provided, the distance between the adjacent terminals 2 can be reduced.

As illustrated in FIG. 5, the first extending portion 61 includes a pair of projection portions 64 protruding in directions opposite to each other in the third direction X3 and including a carrier cut mark CM on the end surface 64a. According to this configuration, it is also possible to minimize the protruding amount, in the third direction X3, of the projection portion 64 including the carrier cut mark CM, which does not need to receive the press-fitting jig. Therefore, the protruding amount of the projection portion 64 including the carrier cut mark CM in the third direction X3 can be adjusted from the above-mentioned minimum to amount an appropriate protruding amount, and the adjustment. of the impedance expands. As a result, the impedance can be more easily matched with high frequency transmission.

In addition, since the protruding amount of the projection portion 64 including the carrier cut mark CM in the third direction X3 can be reduced, the distance between the adjacent terminals 2 can be reduced in the third direction X3, and the substrate connector 1 can be downsized.

As illustrated in FIG. 5, the pair of press-fit protrusions 65 are disposed at the second end portion 62b of the second extending portion 62 adjacent to the curved portion 63. In addition, the second extending portion 62 includes the pressed surface RP extending in the second direction X2 and the third direction X3 as a pressed portion that can be pressed in the first direction X1 in a region including at least the second end portion 62b.

According to this configuration, the distance between the pressed surface RP of the terminal 2 and the first extending portion 61 is short the second direction X2. Therefore, as shown in FIGS. 8A and 8B, when the pressed surface RP of the second extending portion 62 is pressed to press-fit the pair of press-fit protrusions 65 of the second extending portion 62, even if the first extending portion 61 receives frictional force from the insertion hole 35 of the inner housing 3, it is possible to suppress the occurrence of unintended deformation of the curved portion 63 and the like.

According to the method of manufacturing the substrate connector 1 of one preferred embodiment, as shown in FIGS. 8A and 8B, when the second extending portion 62 of the terminal 2 temporarily held in the inner housing 3 is press-fitted and fixed in the accommodation groove 34 of the inner housing 3, the frictional force received by the first extending portion 61 from the insertion hole 35 into which the first extending portion 61 is loosely fitted is small. Therefore, the occurrence of unintended deformation of the curved portion 63 and the like can be suppressed.

In addition, since the distance between the pressed surface RP of the terminal 2 and the first extending portion 61 is short, even if the first extending portion 62 receives frictional force from the insertion hole 35 of the inner housing 3 when the pressed surface RP is pressed to press the pair of press-fit protrusions 65 of the second extending portion 61 into the pair of inner side surfaces 34a of the accommodation groove 34 of the inner housing 3, it is possible to suppress the occurrence of unintended deformation of the curved portion 63 and the like.

In addition, according to the terminal 2 of one preferred embodiment, it is possible to realize the terminal 2 that easily matches impedance with high frequency transmission when used for the substrate connector 1. In addition, according to the terminal 2 of one preferred embodiment, since the distance between the pressed surface RP of the terminal 2 and the first extending portion 61 is short, it is possible to suppress the occurrence of unintended deformation of the curved portion 63 and the like when pressing the pressed surface RP to press-fit and fix the second extending portion 62 in the accommodation groove 34 of the inner housing 3.

The present invention is not limited to the above preferred embodiment. For example, as illustrated in FIG. 11, the press-fitting completion position of the terminal 2 may be positioned by the abutment between the positioning projection portion 34c provided on the groove bottom surface 34b of the accommodation groove 34 and the rear surface 62R (surface opposite to the pressed surface RP) of the second extending portion 62.

In addition, the second connecting portion 22 of the terminal 2 may constitute a surface mount terminal including a portion extending in the first direction X1 along the surface of the circuit board CB. In addition, the terminal 2 may be a single terminal or three or more terminals may be provided.

Although the present invention has been described in detail with reference to specific aspects, those skilled in the art who understand the above content will readily conceive of modifications, changes, and equivalents thereof. Therefore, the present invention should be regarded as being within the scope of the claims and their equivalents.

What is claimed is:

1. A substrate connector comprising:
a terminal including, with a first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion, the bridge portion including a first extending portion extending in the first direction from the first connecting portion, a second extending portion extending in the second direction from the second connecting portion, and a curved portion connecting between the first extending portion and the second extending portion; and
an insulating housing including an end surface in the first direction and an accommodation groove that is provided in the end surface and accommodates the second extending portion and the curved portion, the accommodation groove including a pair of inner side surfaces opposing to each other in the third direction and a groove bottom surface, and an insertion hole that opens in the groove bottom surface of the accommodation groove and extends in the first direction,
wherein the second extending portion includes a pair of press-fit protrusions protruding in directions opposite to each other in the third direction and are press-fitted and fixed in the pair of inner side surfaces of the accommodation groove, and
the first extending portion is loosely fitted to an inner peripheral surface of the insertion hole.

2. The substrate connector according to claim 1, wherein the first extending portion includes a pair of projection portions protruding in directions opposite to each other in the third direction and including a carrier cut mark on an end surface.

3. The substrate connector according to claim 1, wherein the terminal includes a plurality of terminals arranged at predetermined intervals in the third direction.

4. The substrate connector according to claim 1, wherein the pair of press-fit protrusions are disposed at an end portion of the second extending portion adjacent to the curved portion,
the second extending portion includes a pressed portion that is configured to be pressed in the first direction in a region including at least the end portion, and
the pressed portion includes a pressed surface extending in the second direction and the third direction.

5. A method of manufacturing a substrate connector, the method comprising at least steps (S1) and (S2) described below:
(S1) A step of loosely inserting and fitting a part of a first extending portion of a terminal into an insertion hole that opens in a groove bottom surface of an accommodation groove provided in an end surface in a first direction of an insulating housing and extends in the first direction so as to temporarily hold, in the housing, a terminal including, with the first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion, the bridge portion including a first extending portion extending in the first direction from the first connecting portion, a second extending portion extending in the second direction from the second connecting portion, and a curved portion connecting between the first extending portion and the second extending portion; and
(S2) A step of pressing the second extending portion of the temporarily held terminal in the first direction to press-fit and fix a pair of press-fit protrusions provided on the second extending portion protruding in directions opposite to each other in the third direction in a pair of inner side surfaces of the accommodation groove which oppose to each other in the third direction.

6. The method according to claim 5, wherein in the step (S2), the pair of press-fit protrusions are disposed at an end portion of the second extending portion adjacent to the curved portion,
the second extending portion includes a pressed portion configured to be pressed in the first direction in a region including at least the end portion, and
the pressed portion includes a pressed surface extending in the second direction and the third direction.

7. A terminal comprising, with a first direction, a second direction, and a third direction being three orthogonal directions, a first connecting portion extending in the first direction and connectable to a mating terminal, a second connecting portion extending in the second direction and connectable to a substrate, and a bridge portion connecting the first connecting portion and the second connecting portion,
wherein the bridge portion includes a first extending portion extending in the first direction from the first connecting portion, a second extending portion extending in the second direction from the second connecting portion, and a curved portion connecting between the first extending portion and second extending portion, and
the second extending portion includes a pair of press-fit protrusions protruding in directions opposite to each other in the third direction.

8. The terminal according to claim 7, wherein the first extending portion includes a pair of projection portions protruding in directions opposite to each other in the third direction and including a carrier cut mark on an end surface. 20

9. The terminal according to claim 7, wherein the pair of press-fit protrusions are disposed at an end portion of the second extending portion adjacent to the curved portion,
the second extending portion includes a pressed portion that is configured to be pressed in the first direction in a region including at least the end portion, and
the pressed portion includes a pressed surface extending in the second direction and the third direction.
